(19) United States
(12) Patent Application Publication
(10) Pub. No.: US 2018/0142455 A1
(43) Pub. Date: May 24, 2018

(54) Piston Flush Toilet with a Lubricating Piston

(71) Applicants: David R. Hall, Provo, UT (US); John Christensen, Bluffdale, UT (US); Daryl Wise, Provo, UT (US); Matthew Goodson, Yucaipa, CA (US); Cameron Price, Provo, UT (US)

(72) Inventors: David R. Hall, Provo, UT (US); John Christensen, Bluffdale, UT (US); Daryl Wise, Provo, UT (US); Matthew Goodson, Yucaipa, CA (US); Cameron Price, Provo, UT (US)

(21) Appl. No.: 15/359,105

(22) Filed: Nov. 22, 2016

(51) Int. Cl. E03D 9/10; E03D 5/012; G02B 21/00

(52) U.S. Cl. CPC E03D 9/10; G02B 21/0004; E03D 5/012

(57) ABSTRACT

A piston flush toilet apparatus is disclosed. The piston flush toilet apparatus comprises one or more leaky piston seals which allow lubrication to leak in a predetermined direction. The leaky lubrication keeps waste from entering unwanted areas of the piston drive system while also lubricating the piston and macerated waste. An internal piston maceration system is also disclosed and claimed. Additionally, a microscope and light built into the piston is also disclosed and claimed.

### FIELD OF THE INVENTION

The present invention generally relates to piston flush toilets and more specifically relates to piston seals and piston lubrication of a piston flush toilet.

### BACKGROUND OF THE INVENTION

Common toilet systems currently in use consume large amounts of water. There are several reasons for this. First, water acts as a transport medium allowing waste to travel through piping networks. Second, water blocks odors from waste and from sewer systems from reaching users.

As populations age, there is an increasing need for daily health monitoring systems for early detection of preventable illnesses. Ideally, such health monitoring systems would perform their duties with as little inconvenience to the individual being monitored as possible. A variety of information about a person's health can be derived from their excrement. As such, there have been various attempts to incorporate health monitoring systems into toilet systems which people use every day.

For example, U.S. Pat. No. 4,636,474 to Ogura et al., which is incorporated herein for all that it contains, discloses a toilet apparatus comprising a detecting sensor for detecting constituents in the feces, urine, or both of a user, and an indicator for indicating or informing the user of his health based upon abnormalities in the constituents detected by the sensor. It has been found that the amount of water used in many current toilet systems dilutes samples thus hindering health monitoring. Thus, in health-monitoring toilet applications, the need for low-water solutions is even greater.

One attempt to create a low-water toilet is shown in U.S. Pat. No. 3,585,649 to

Miya, which is incorporated herein for all that it contains. Miya discloses a defecating system in which foam is provided. Excrement is sealed by the foam visually and hygienically without necessity of an appreciable quantity of water.

Another example of a low-water toilet system is disclosed in U.S. Pat. No. 6,910,231 to Breiing et al., which is incorporated herein for all that it contains. Breiing et al. discloses means for transporting a material from a toilet pan into a sanitation pipe comprising two valves which are arranged in a pipe and a pressure chamber disposed in-between. Rather than water, the pressure chamber creates suction which transports the waste. Accurate control of the multiple valves and pressure chamber are necessary which may increase complication and cost.

An example of a health-monitoring toilet system that attempts to mitigate water dilution is shown in U.S. Pat. No. 4,962,550 to Ikenaga et al., which is incorporated herein for all that it contains. Ikenaga et al. discloses a toilet with a device for measuring constituents of voided urine. The toilet has a urine reservoir having a surface contiguous to a bowl surface including a urine receiving surface. Urine examined by the measuring device is sampled from the urine reservoir before it enters any water.

An example of a health-monitoring toilet system that attempts to mitigate water dilution is shown in U.S. Pat. No. 9,416,524 to Hall et al., which is incorporated herein for all that it contains. Hall et al. discloses a piston-flush toilet system including apparatus and methods for measuring waste with a microchip and using compressed air to actuate a toilet piston.

While there have been various attempts at producing both low-water toilets and health-monitoring toilets there is still much room for improvement in the art.

### SUMMARY

This invention has been developed in response to the present state of the art including problems and needs in the art that have not yet been fully solved by currently available systems and methods. Accordingly, a piston flush toilet apparatus has been developed. Features and advantages of different embodiments of the invention will become more fully apparent from the following description and appended claims, or may be learned by practice of the invention as set forth hereinafter.

The piston flush toilet apparatus decreases the use of water by eliminating the need for a traditional water flush toilet. A lubricant on the surface of a toilet bowl eases the passage of user waste into a piston chamber. Once in the piston chamber, the waste is combined with more lubricant, and a piston forces the waste and lubrication mixture into a maceration drive that combines them into a slurry. From this point the slurry can be analyzed by a microscope and disposed of with minimal water used throughout the disposal process.

The piston flush toilet apparatus comprises a piston which pushes waste through a drain. The piston comprises a first and second end, and four seals that contain waste in the system until it is disposed through the drain. Lubrication is dispensed through lubricating ports, which helps the components of the piston flush toilet apparatus function more fluidly. The lubricating ports may be found between first and second seals on a first end of the piston and/or between third and fourth seals on a second end of the piston of the apparatus. The lubrication may be dispensed through the first lubricating port causing the lubrication to leak past the first seal on a first end of the piston in a predetermined direction. Additionally, lubrication may be dispensed through a second lubricating port causing the lubrication to leak past a third seal on a second end of the piston in a predetermined direction. The lubrication used with the piston flush toilet apparatus may comprise compressed air, water, surfactants, foam, or a combination thereof. Supply for the lubricating ports comes from a common lubrication channel that is connected to a source of lubrication. Lubrication is provided independently to the piston and the maceration drive, the lubrication provided may be relatively uniform in composition.

The piston is moved between first and second ends by means of two screw drives that are mobilized by a first multi-gear motor. One of the ends comprises a maceration drive system that macerates waste with the lubrication to make a slurry. The maceration drive system further comprises a maceration blade, a multi-gear motor, and two belts used by the motor to effectively mix the contents of the piston flush toilet apparatus.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 shows a side cross-sectional view of the piston flush toilet apparatus;

FIG. 2 shows an angled side cross-sectional view of the piston and piston chamber of the piston flush toilet apparatus;

FIG. 3 is an isometric cross-sectional view of the piston used in the piston flush toilet apparatus;

FIG. 4 displays an end of the piston flush toilet apparatus;

FIG. 5 charts the use of lubrication in the piston flush toilet apparatus;

FIG. 6 charts the order of functions in the piston flush toilet apparatus;

FIG. 7 displays another end of the piston flush toilet apparatus;

FIG. 8 shows a view of a maceration drive of the piston flush toilet apparatus;

FIG. 9 is an interior view of components within the maceration drive; and

FIG. 10 is a cross-sectional side view of a microscope within the piston flush toilet apparatus.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

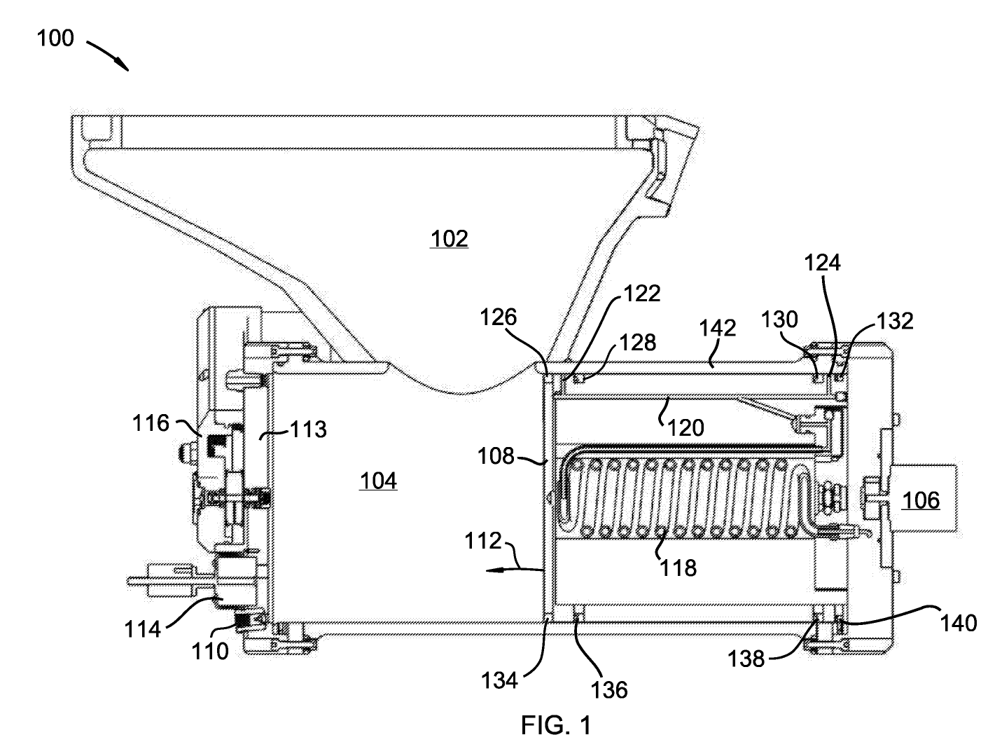

FIG. 1 shows a piston flush toilet apparatus 100. A motor 106 controls the motion of a first end 108 to move in the direction 112 towards a discharge end 113, or to move opposite the direction 112. A user may deposit waste into a toilet bowl 102 which will subsequently pass to a piston chamber 104. The waste is forced by the first end 108 into a maceration drive 116 where it is processed into a slurry. The slurry may then be disposed by means of a drain port 110. Lubrication passes through a lubrication hose 118 to lubrication tubing 120 on to a first lubrication port 122 and a second lubrication port 124. The supplied lubrication is used to decrease friction between an exterior wall 142 and a first seal 126, 134, a second seal 128, 136, a third seal 130, 138, and fourth seal 132, 140 and to keep waste moving in a direction of drain 110. The lubrication is allowed to pass unidirectionally through the seals in the direction 112 keeping waste in front of piston surface 108. The lubrication is then also mixed with a user's waste before the waste is passed to the maceration drive 116. The lubrication may be dispensed through the first lubricating port 122 causing the lubrication to leak past the first seal 126 on a first end of the piston 108 in a predetermined direction. Additionally, lubrication may be dispensed through a second lubricating port 124 causing the lubrication to leak past a third seal 130 on a second end of the piston in the same predetermined direction as the predetermined direction of the first seal. The predetermined leaky direction of both the first seal and the third seal is toward drain 110.

The drive screw is protected from contamination by and exterior wall 142, a first seal 126, 134, a second seal 128, 136, a third seal 130, 138, and fourth seal 132, 140. The seals are unidirectional such that substances are allowed to pass through the seals in the direction 112 but not in the opposite direction. The piston flush toilet apparatus 100 further comprises a first lubrication port 122 and a second lubrication port 124 and lubrication piping 120. User waste may be viewed or analyzed by a microscope 114. The lubrication used may comprise air, water, surfactants, foam, a combination thereof, or other known and useful lubricants.

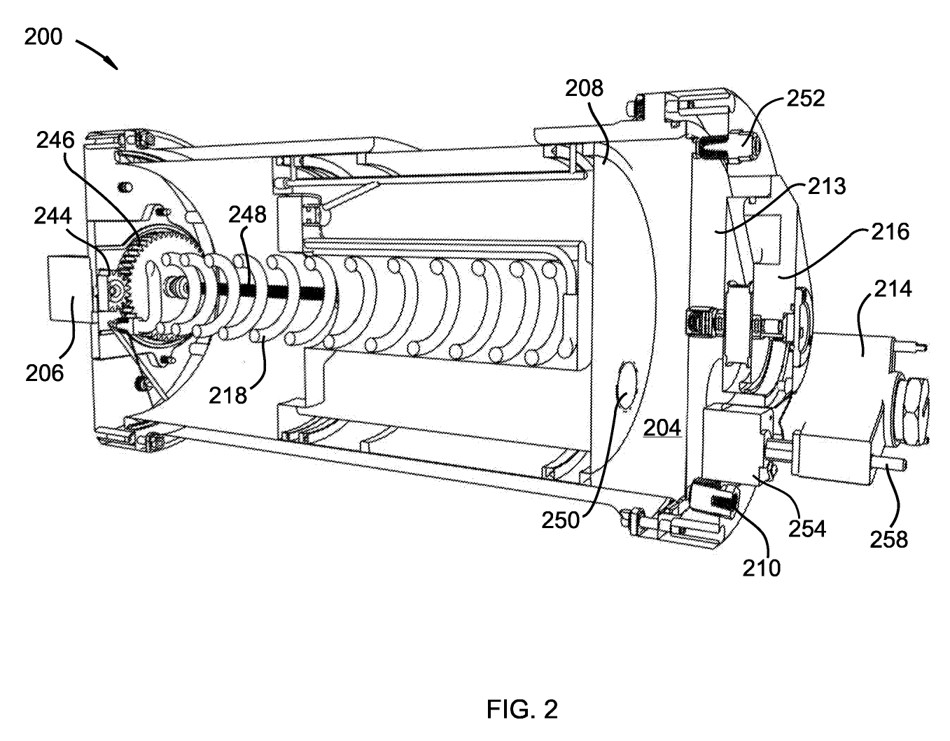

FIG. 2 displays a piston apparatus 200 comprising a motor 206 that powers a screw drive 248 by rotation of a large gear 246 and a small gear 244 powered by the motor 206. Operation of the screw drive 248 by the motor 206 causes motion of a first end 208 towards a discharge end 213. Compression in a piston chamber 204 causes contents of the piston chamber 204 to pass into a maceration drive 216, where waste and lubricant are macerated to create a slurry. The slurry is passed to a drain 210 which may be attached to some central sewage system. The piston apparatus 200 further comprises a microscope 214 that can slide along a guide rod 258. A light source 250 illuminates the waste such that the microscope can view and image it for subsequent analysis.

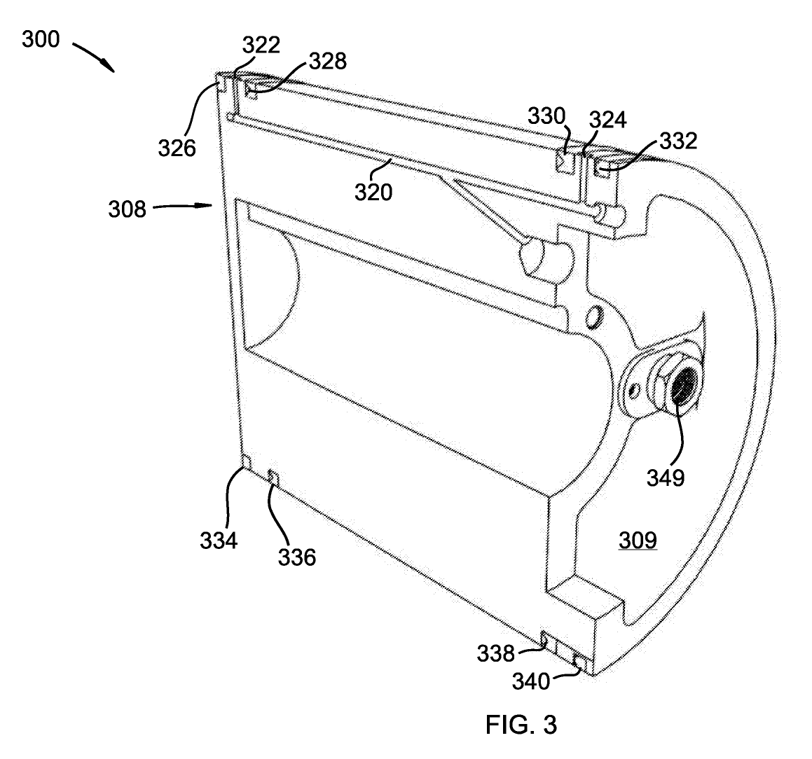

FIG. 3 shows a piston component 300 comprising a first end 308 and a second end 309. A motor attaches to the piston component at an attachment 349. Lubrication is distributed at lubrication ports 322 and 324. Lubrication is supplied to the lubrication ports 322 and 324 by means of lubrication piping 320. A first seal 326, 328, 336, 334 and a second seal 330, 332, 338, 340 are comprised in the piston component 300. The first seal 326, 328, 336, 334 and the second seal 330, 332, 338, 340 may be used to prevent substance flow or to allow only unidirectional substance flow. The lubrication may be dispensed through the first lubricating port 322 causing the lubrication to leak past the first seal 326 on a first end 308 of the piston toward a predetermined direction of piston end 308. Additionally, lubrication may be dispensed through a second lubricating port 324 causing the lubrication to leak past a third seal 330 on a second end 309 of the piston toward a predetermined direction of piston end 308. Seals 328 and 330 may be directional seals allowing lubrication to flow past the seals in a direction towards piston end 308 while blocking lubrication flow in a direction towards piston end 309. The directional seals 328 and 330 may have a triangular cross-section as shown in FIG. 3. The triangular cross-section allows the seals to pass lubrication in a direction towards piston end 308 by collapsing or folding under lubrication pressure or friction caused by the moving of the piston. The triangular cross-section also flares out under pressure and keeping lubrication from passing in the direction of piston end 309.

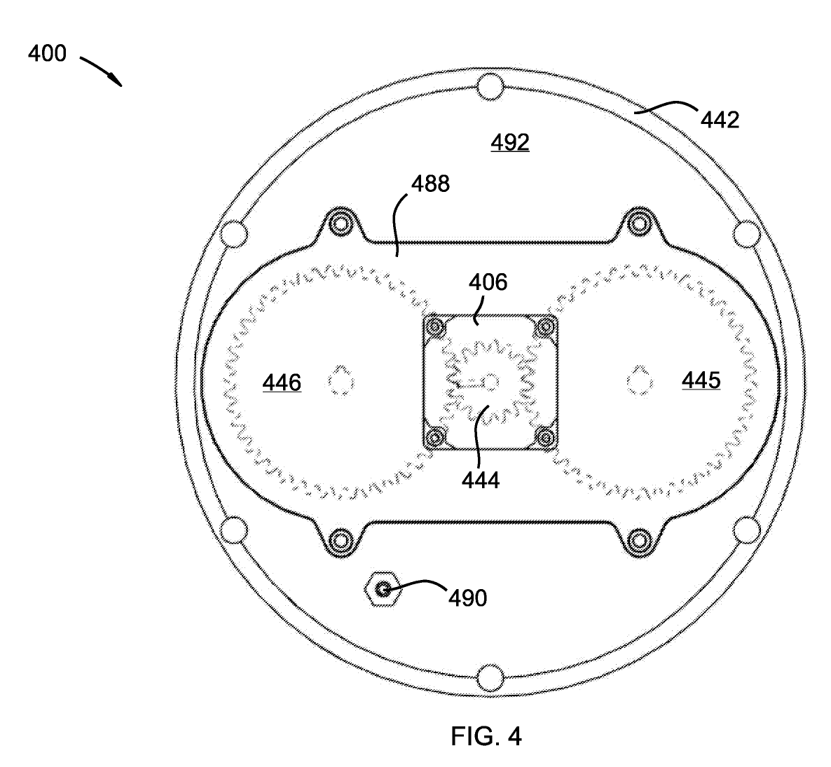

FIG. 4 comprises a view of a second end 400 of a piston flush apparatus. Three gears are visible, a large left gear 446, a small gear 444, and a large right gear 445. The large left gear 446 and the large right gear 445 both turn screw drives (not shown) within the body of the piston flush apparatus. They are both supplied force for rotation from the small gear 444 which is in turn powered by a motor 406. The large left, large right, and small gears 446, 445, 444 are concealed from view by a cover 488 that is mounted on a second end 492. An inlet channel 490 is provided for the passage of lubrication into to piston flush apparatus.

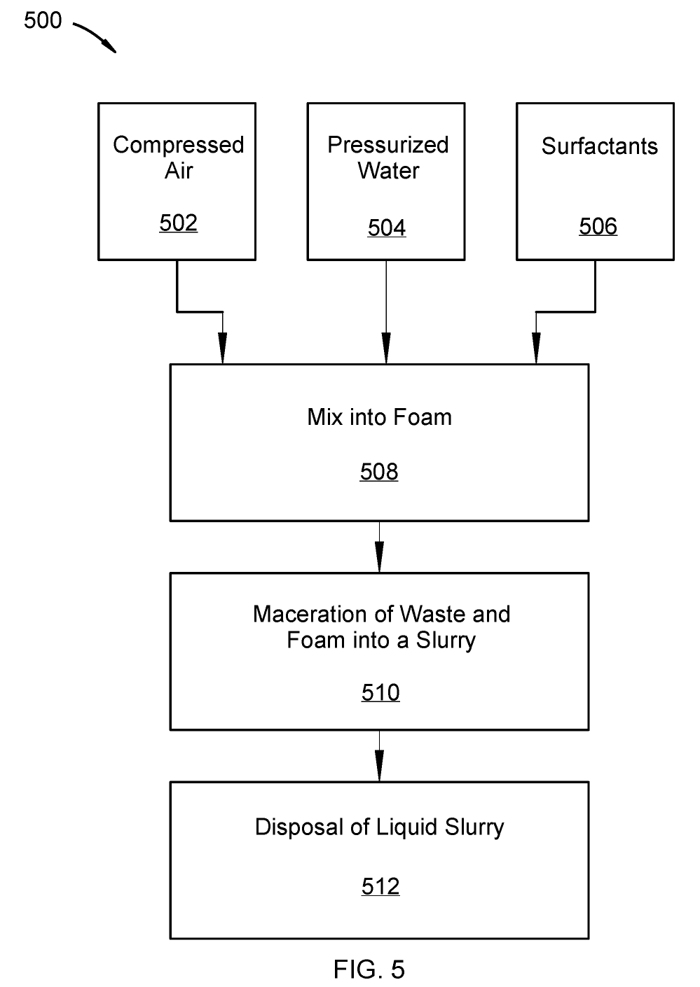

FIG. 5 describes a method 500 for the use of lubrication in a piston flush toilet apparatus. The steps of operation 500 are initiated with a supply of lubricant, which may be in the form of compressed air 502, pressurized water 504, surfactants 506, or some other medium. The lubricant is then mixed 508 into a foam. The foam may be used as a lubricant for the piston, a lubricant for the passage a user's waste through the apparatus, and a lubricant for the maceration drive. Following a waste deposit by a user, the waste and lubricant mixture is macerated 510 into a slurry. This slurry is then disposed from the system.

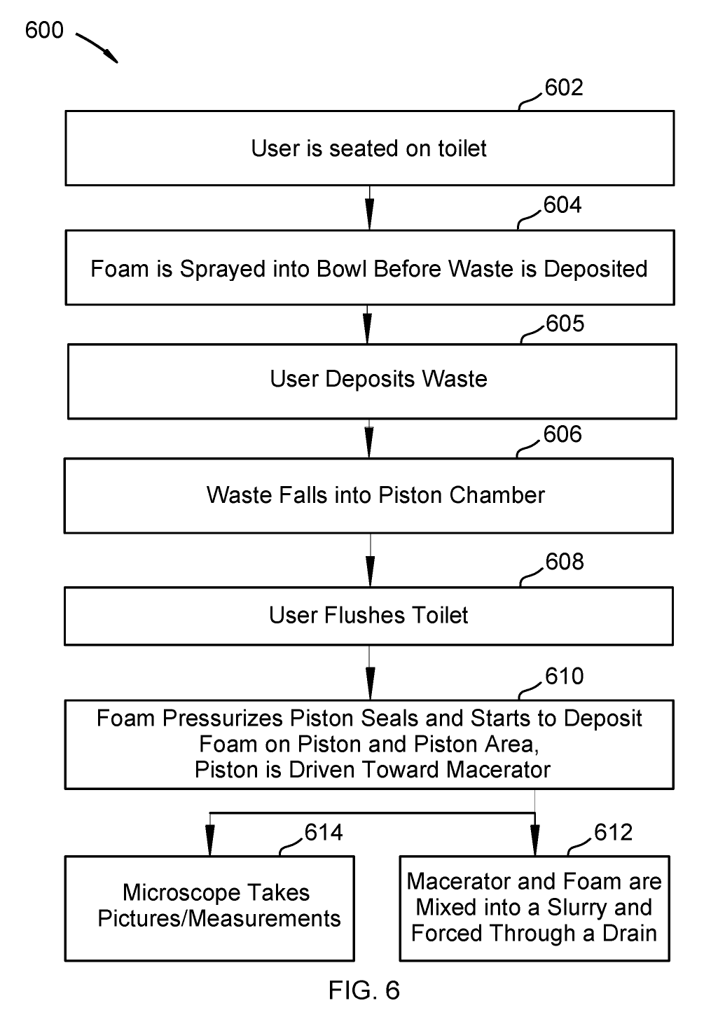

FIG. 6 describes a method 600 for the function of a piston flush toilet apparatus. Initially, a user is seated 602 on a toilet that has a piston flush system installed. Foam is then sprayed 604 into the toilet bowl before waste is deposited by the user. Following spraying 604 of the foam the user deposits 605 waste into the toilet bowl. Following waste deposition, collected waste falls 606 into a piston chamber of the piston flush toilet apparatus. The user then flushed 608 which triggers the processes 610 of the piston flush system. The processes 610 of the piston flush system include foam pressurizing the piston seals as well as foam being deposited on the piston and within the piston chamber, followed by the piston being driven toward a maceration drive. The macerator mixes the waste and foam into a slurry 612 that is then passed in front of a microscope 614 before being drained from the piston flush toilet apparatus.

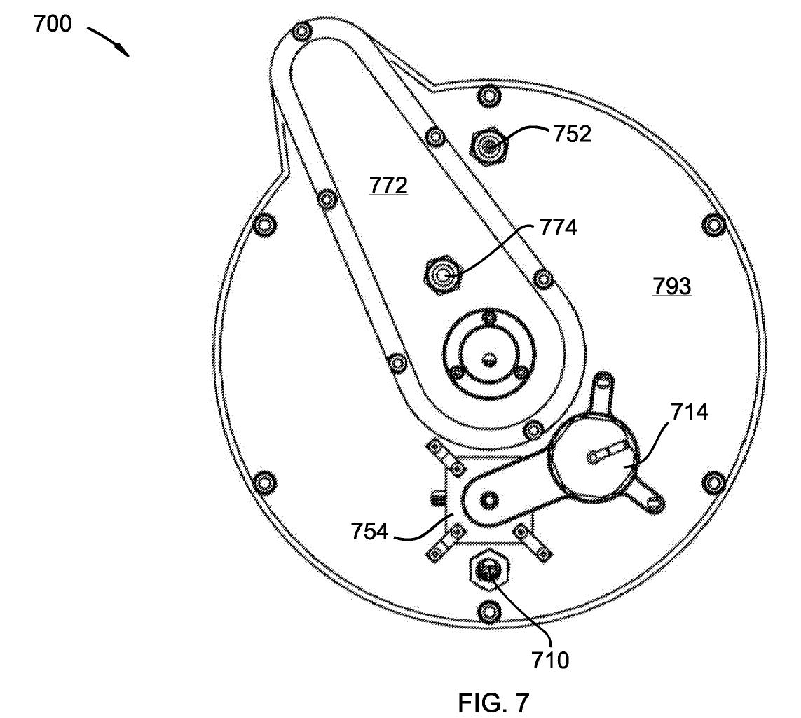

FIG. 7 displays a view of discharge end 700 of a piston flush system. A combination of waste and foam lubrication is pushed towards the front end 700 where it enters a macerator device, concealed behind a first cover 793. A power belt is concealed behind a second cover 772. Also comprised in the front end 700 is a microscope 714, and a microscope motor 754. The microscope motor 754 controls motion of the microscope necessary for making focused observations. Further comprised in the front end 700 is a drain 710 where a slurry of waste and lubrication exits a piston flush system after passing through the maceration drive. Lubrication ports 752 and 774 are also visible, which may allow for lubrication to be passed into the piston flush system.

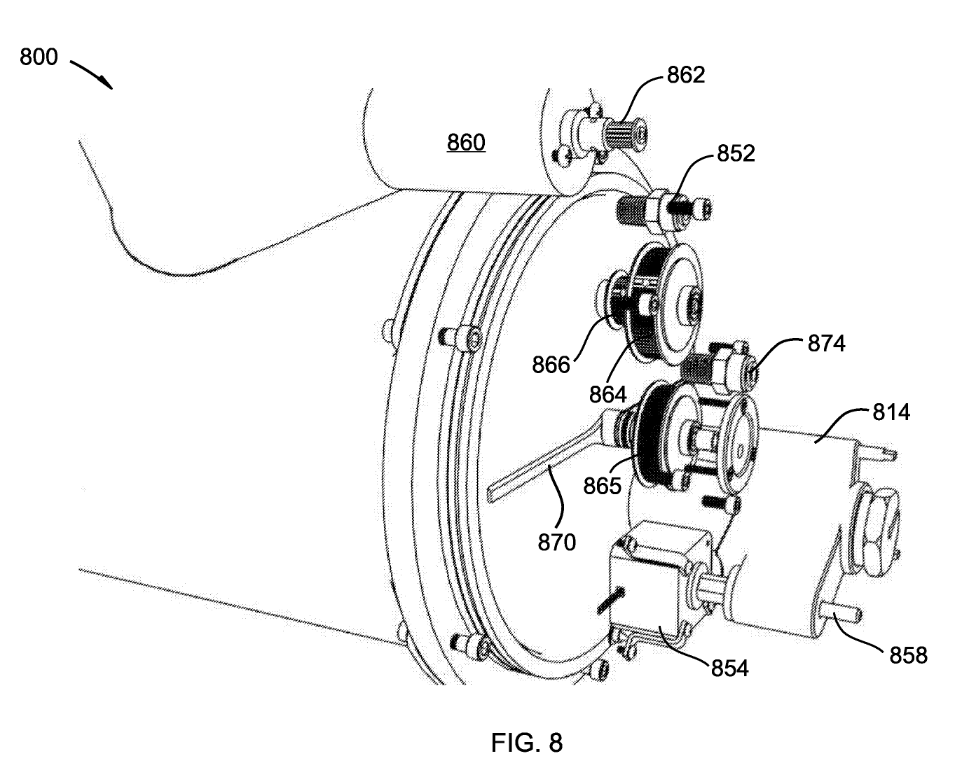

FIG. 8 displays a maceration drive system 800 operating in conjunction with a piston flush toilet apparatus. The maceration drive system comprises a maceration blade 870, a maceration drive motor 860 that further comprises a gear 862 which may be connected to gears 864, 865, or 866 by means of a first and second power belt. The gears 864, 865, and 866 collectively enable the maceration drive system 800 to operate in up to four different gears. It also comprises channels 874 and 852 such that lubrication may be fed into a main chamber of the piston flush toilet apparatus from an exterior source. A microscope motor 854 controls the motion of a microscope 814 along a guide rod 858. The microscope 814 may be used to observe and analyze the slurry that results from maceration of user waste and lubrication.

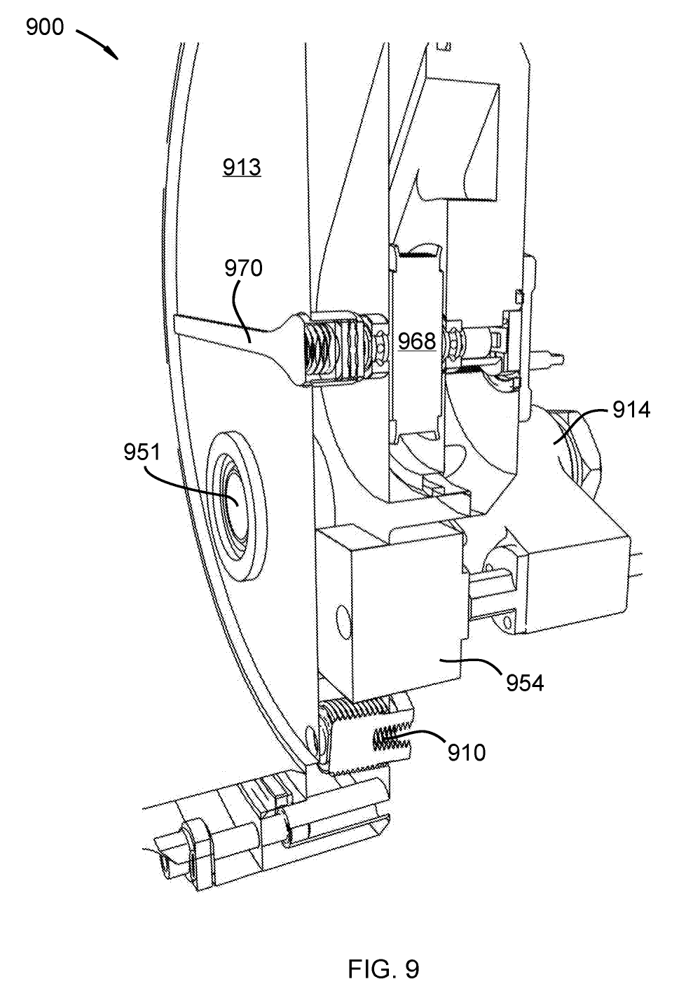

FIG. 9 displays a portion of a piston flush toilet apparatus 900. A maceration drive system 913 is displayed, wherein a maceration blade 970 powered by a maceration drive motor 968 is used to macerate a mixture of waste and lubrication. The mixture may be observed through an observation port 951 by a microscope 914 that is adjusted by means of a motor 954. Following maceration, the slurry may be discarded by means of a drain 910.

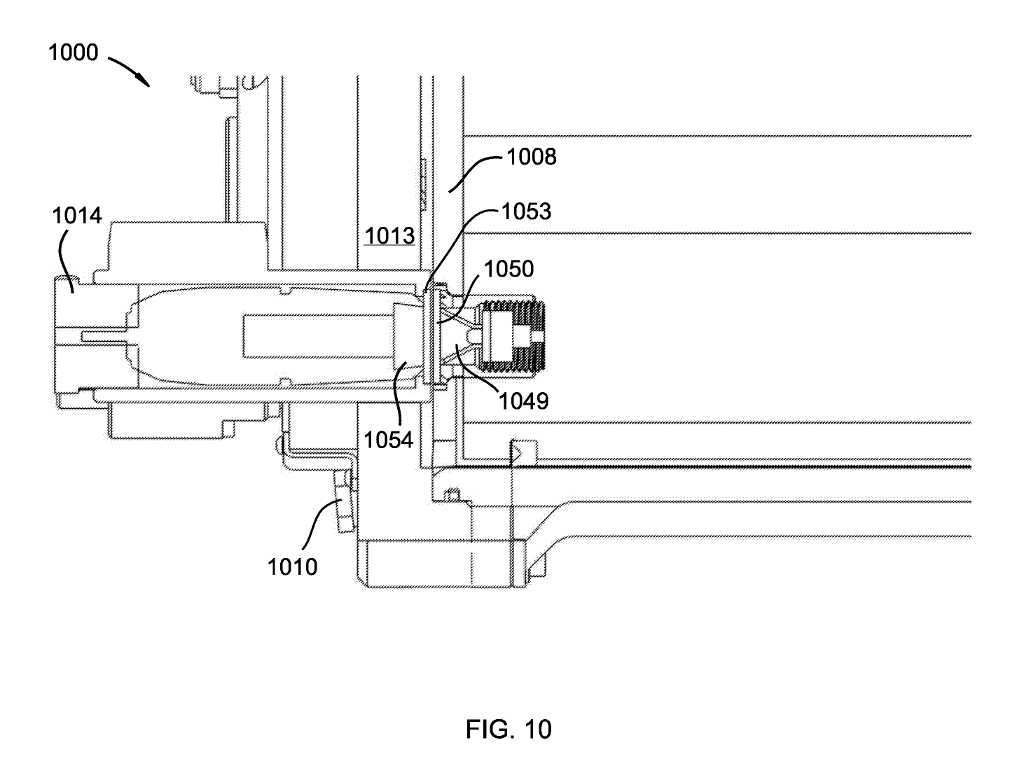

FIG. 10 displays a microscope observation system 1000 that functions as a part of a piston flush toilet apparatus. A maceration drive 1013 macerates a mixture of user waste and lubrication into a slurry which then passes between a light permeable surface 1050 and a transparent surface 1053, and can be photographed or observed by means of microscopic lens 1054. A drain 1010 allows for elimination of the slurry after maceration and observation. A drive system 1014 is used to operate the microscopic lens 1054. The drive system 1014 may comprise a hydraulic piston, and electronic motor, a computer, a processor, or other components used for operation of the microscopic lens 1054. A light source 1049 is embedded into a second end 1008, therein providing light for observation of the macerated slurry.

The systems and methods disclosed herein may be embodied in other specific forms without departing from their spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A piston flush toilet apparatus comprising:
a piston which pushes toilet waste thorough a drain, the piston comprising a first end and a second end, the first end of the piston comprising a first seal and a second seal;
a first lubricating port located between the first seal and the second seal; and
wherein as the piston pushes the toilet waste, lubrication is dispensed through the first lubricating port causing the lubrication to leak past the first seal in a predetermined direction.

2. The piston flush toilet apparatus of claim 1, further comprising a third seal and a fourth seal located on the second end.

3. The piston flush toilet apparatus of claim 2, further comprising a second lubricating port located between the third seal and the fourth seal.

4. The piston flush toilet apparatus of claim 3, wherein the first seal and third seal are both unidirectional seals allowing the lubrication to flow in the predetermined direction.

5. The piston flush toilet apparatus of claim 4, wherein the lubrication further comprises water.

6. The piston flush toilet apparatus of claim 5, wherein the lubrication further comprises surfactants.

7. The piston flush toilet apparatus of claim 1, wherein the lubrication comprises foam.

8. The piston flush toilet apparatus of claim 1, further comprising first and second screw drives that pushes the piston.

9. The piston flush toilet apparatus of claim 1, further comprising a common lubrication channel that supplies lubrication to the first lubrication port and to the second lubrication port.

10. The piston flush toilet apparatus of claim 1, further comprising a maceration drive system.

11. The piston flush toilet apparatus of claim 10, wherein the maceration drive system further comprises a microscope situated to make visual observation of waste.

12. The piston flush toilet apparatus of claim 10, wherein the maceration drive system further comprises a maceration blade disposed inside of the piston flush toilet apparatus.

13. The piston flush toilet apparatus of claim 12, further comprising a first lubrication input port, a second lubrication input port, and a third lubrication input port.

14. The piston flush toilet apparatus of claim 13, wherein the third lubrication input port supplies lubrication to the maceration drive system.

15. The piston flush toilet apparatus of claim 13, wherein the second lubrication input port supplies lubrication to an inner chamber of the piston flush toilet apparatus where the waste is macerated into a slurry of waste and lubrication.

16. The piston flush toilet apparatus of claim 13, wherein the first lubrication input port supplies lubrication to the piston.

17. The piston flush toilet apparatus of claim 13, wherein the lubrication supplied to the first lubrication port, the second lubrication port, and the third lubrication port is substantially similar in composition.

18. The piston flush toilet apparatus of claim 9, further comprising a first motor which drives the first drive screw and the second drive screw with a first gear, a second gear, and a third gear.

19. The piston flush toilet apparatus of claim 12, further comprising a second motor which drives the maceration drive system.

20. The piston flush toilet apparatus of claim 19, wherein the maceration drive system drives the maceration blade with a fourth gear, a fifth gear, a sixth gear, and a seventh gear using a first belt and a second belt.
